(19) United States
(12) Patent Application Publication
(10) Pub. No.: US 2024/0351305 A1
(43) Pub. Date: Oct. 24, 2024

(54) COMPOSITE INSULATION PANEL

(71) Applicant: Pacific Insulated Panel LLC (d/b/a R-Seal), Sultan, WA (US)

(72) Inventor: Jeffrey BAHNMILLER, Sultan, WA (US)

(73) Assignee: Pacific Insulated Panel LLC (d/b/a R-Seal), Sultan, WA (US)

(21) Appl. No.: 18/623,718

(22) Filed: Apr. 1, 2024

Related U.S. Application Data
(60) Provisional application No. 63/456,767, filed on Apr. 3, 2023.

(51) Int. Cl. B32B 5/24; B32B 5/02; B32B 5/18; B32B 27/12; E04B 1/62; E04B 1/80; E04B 1/94

(52) U.S. Cl. CPC B32B 5/245; B32B 5/024; B32B 5/18; B32B 27/12; E04B 1/625; E04B 1/80; E04B 1/947; B32B 2255/02; B32B 2255/20; B32B 2260/021; B32B 2260/04; B32B 2264/108; B32B 2264/201; B32B 2266/0278; B32B 2307/304; B32B 2307/3065; B32B 2307/54; B32B 2307/7246; B32B 2607/00

(57) ABSTRACT

A composite building insulation panel includes a rigid foam core having a planar surface, a facing bonded to the planar surface, and at least one layer of mesh embedded within the foam core. The facing includes an outer skin layer and a reinforcing layer between the planar surface and the outer skin layer. The embedded mesh may be coated with an intumescent material.

### CROSS REFERENCE OF RELATED APPLICATION

This application claims the benefit under 35 U.S.C. § 119(e) of the filing date of U.S. provisional patent application Ser. No. 63/456,767 filed Apr. 3, 2023, the disclosure of which is incorporated herein by reference.

### FIELD OF THE DISCLOSURE

This disclosure relates to composite panels for industrial insulation, and more particularly to composite panels including two composite facings covering opposed surfaces of a foam core and a reinforcing mesh and/or an intumescent-coated mesh embedded in the foam core.

### BACKGROUND

Demand for energy efficient buildings and build products is increasing due to increasing energy costs and stricter building energy standards. Composite insulating building panels including polyurethane-modified polyisocyanurate (PU-PIR) foams are an economical approach for high R-value continuous insulation for buildings. Conventional composite insulation building panels comprise a foam core, e.g. polyurethane-modified polyisocyanurate (PU-PIR) foams, with a surface facing on one or both surfaces of the foam core. The surface facing may be a laminate comprised of an outer layer, such as, a white polypropylene, a reinforcing material (e.g., a mesh), and a metalized polyester, wherein the various layers are held together by an adhesive (see, e.g., U.S. Pat. No. 8,635,828).

While a reinforcing mesh provided in a surface facing laminate may reinforce the composite panel at the surface or surfaces of the foam core at which the facing is applied, facing does not provide reinforcing within the foam core itself away from the surface.

In addition, composite insulation building panels may be formed with fire retardant properties by combining flame retardant additives with the foam blend. Such flame retardant additives may include a brominated polymer with aliphatic bromine (see, e.g., U.S. Pat. No. 9,441,108) and a high molecular weight ammonium polyphosphate (APP) (see, e.g., U.S. Pat. No. 8,916,620).

Halogenated fire retardant additives can migrate from the foam matrix and are not environmentally friendly materials. And distributing a foam retardant additive throughout the foam core thickness, as opposed to being concentrated near an outer surface of the foam core, dilutes the fire retardant effectiveness of the additive, especially for relatively thick foam panels, thereby requiring an increased amount of the fire retardant additive to achieve a desired (required) fire retardant performance. On the other hand, increased concentrations of flame retardant additives within the foam blend can adversely impact the foam's mechanical properties and its insulating efficiency.

It has been proposed to apply fire retardant material—e.g. intumescent fire retardant material—as a coating over the top of installed insulating materials, but such processes are expensive and the coating is vulnerable to damage.

### SUMMARY OF THE DISCLOSURE

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

Subject matter described herein includes a composite foam panel including a mesh material that is embedded in the foam core beneath an outer surface of the panel at which a facing is applied to the foam core. The embedded mesh may be coated within an intumescent material to provide fire retardant properties concentrated within the foam core and not in an exposed state vulnerable to damage.

According to one aspect of the disclosure, a composite building insulation panel comprises a rigid foam core having a planar surface, a facing bonded to the planar surface, the facing comprising an outer skin layer; and a reinforcing layer between the planar surface and the outer skin layer and comprising woven fibers; and at least one layer of mesh embedded within the foam core to reinforce the foam core.

According to another aspect of the disclosure, the mesh is a carrier mesh coated with an intumescent material.

According to another aspect of the disclosure, the carrier mesh comprises a leno mesh in which two warp yarns are woven around the weft yarns, wherein the mesh is characterized by dimensions d1 which is the warp/weft density, i.e., umber of yarns per unit length, and d2 which is the yarn thickness, and wherein a ratio of yarn thickness to density (d2/d1) is 0.12 to 0.34.

According to another aspect of the disclosure, materials of the mesh include at least one of fiberglass, including E-Glass and/or S-Glass, Kevlar®, carbon fiber, ceramics, stainless steel, and galvanized steel.

According to another aspect of the disclosure, the intumescent material comprises flake graphite.

According to another aspect of the disclosure, the intumescent material is bound to the carrier mesh by a PVAc-based glue.

According to another aspect of the disclosure, the graphite flake exfoliates at a temperature of 320° F. to 536° F. (160° C. to 280° C.).

According to another aspect of the disclosure, the intumescent material is coated primarily on only one side of the carrier mesh.

According to another aspect of the disclosure, the mesh is embedded within the foam core below the planar surface of the foam core and closer to the planar surface than to a midpoint of a thickness of the foam core, preferably at a dept of about 1/16 inch to 1/32 inch.

According to another aspect of the disclosure, the foam core has opposed planar surfaces and wherein the at least one layer of mesh embedded within the foam core comprises a first layer of reinforcing mesh embedded in the foam core near one of the opposed planar surfaces and a second layer of reinforcing mesh embedded in the foam core near the other of the opposed planar surfaces.

According to another aspect of the disclosure, at least one of the first layer of reinforcing mesh and the second layer of reinforcing mesh is coated with an intumescent material.

According to another aspect of the disclosure, the facing extends beyond an edge of the foam core.

According to another aspect of the disclosure, the composite building insulation panel further comprises an adhesive applied to a portion of the facing extending beyond the edge of foam core.

According to another aspect of the disclosure, the outer skin layer is at least partially vapor impervious.

According to another aspect of the disclosure, the outer skin layer is configured to have a class I water vapor transmission rating of 0.0 perm to 0.1 perm.

According to another aspect of the disclosure, the outer skin layer comprises plastic film.

According to another aspect of the disclosure, the outer skin layer is comprised of a material selected from the group consisting of metalized polypropylene, polystyrene, polyethylene, polypropylene, polyurethane, and polyvinylchloride.

According to another aspect of the disclosure, the foam core comprises polyurethane foam.

According to second aspect of the disclosure, a coating line for forming an intumescent-coated sheet and comprising at least one row of binder sprayers and at least one row of deposit devices, wherein each row of binder sprayers is configured to apply a binder material to a carrier sheet passing though the line and each row of deposit devices is configured to deposit flake material onto a portion of the carrier sheet that is coated with a binder.

According to a third aspect of the disclosure, a composite building insulation panel comprises a rigid foam core having a planar surface, a facing bonded to the planar surface, the facing comprising an outer skin layer and a reinforcing layer between the planar surface and the outer skin layer and comprising woven fibers, and a fire barrier layer applied to or embedded within the foam core and disposed beneath the facing so as to be closer to the planar surface than to a center of a thickness of the foam core, wherein the fire barrier layer comprises an intumescent material.

According to another aspect, the fire barrier layer comprises a carrier sheet on which the intumescent material is coated.

According to another aspect, the carrier sheet comprise at least one of a mesh, a fabric, a film, a paper product, or linear fibers.

According to another aspect, the carrier sheet comprises a reinforcing mesh.

According to another aspect, the carrier sheet comprises a leno mesh in which two warp yarns are woven around the weft yarns, wherein the mesh is characterized by dimensions d1 which is the warp/weft density, i.e., umber of yarns per unit length, and d2 which is the yarn thickness, and wherein a ratio of yarn thickness to density (d2/d1) is 0.12 to 0.34.

According to another aspect, the carrier sheet comprises a mesh including at least one of fiberglass, including E-Glass and/or S-Glass, Kevlar®, carbon fiber, ceramics, stainless steel, and galvanized steel.

According to another aspect, the intumescent material comprises flake graphite.

According to another aspect, the intumescent material is bound to the carrier sheet by a PVAc-based glue.

According to another aspect, the graphite flake exfoliates at a temperature of 320° F. to 536° F. (160° C. to 280° C.).

According to another aspect, the carrier sheet comprises a carrier mesh and the intumescent material is coated primarily on only one side of the carrier mesh.

According to another aspect, the fire barrier layer is embedded within the foam core at a depth of about 1/32 inch to 1/16 inch below the planar surface of the foam core.

According to another aspect, the facing extends beyond an edge of the foam core.

According to another aspect, the composite building insulation panel further comprises an adhesive applied to a portion of the facing extending beyond the edge of foam core.

According to another aspect, the outer skin layer is at least partially vapor impervious.

According to another aspect, the outer skin layer is configured to have a class I water vapor transmission rating of 0.0 perm to 0.1 perm.

According to another aspect, the outer skin layer comprises plastic film.

According to another aspect, the outer skin layer is comprised of a material selected from the group consisting of metalized polypropylene, polystyrene, polyethylene, polypropylene, polyurethane, and polyvinylchloride.

According to another aspect, the foam core comprises polyurethane foam.

According to another aspect, the foam core comprises polyurethane-modified polyisocyanurate (PU-PIR) foam.

According to another aspect, a coating weight of the intumescent-material on the carrier sheet is 20-400 lbs./1000 ft².

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements.

FIG. 1 is a perspective view of a composite insulation panel wherein the layers have been pulled back and exposed on one side of the composite panel. The same layers that have been exposed may also be present on the second major side of the composite.

FIG. 2 is a side view of the composite structure shown in FIG. 1 without the layers of said composite exposed.

FIG. 3 is an exploded view a composite panel and panel molding fixture prior to expansion of the foam.

FIG. 4 is a perspective view, including Detail “A,” of a composite insulation panel, wherein layers have been pulled back and exposed on one side of the composite panel.

FIG. 5 is a photograph showing opposed sides of an exemplary intumescent-coated mesh.

FIG. 6 is a close-up photograph showing details of an exemplary carrier mesh.

FIG. 7 is a photograph showing an uncoated carrier mesh, an intumescent-coated mesh, and an expanded (exfoliated) carbon char layer side by side.

FIG. 8 is a close-up photograph of the expanded carbon char layer on top of a panel with a layer of unexpanded intumescent-coated mesh embedded within the foam core below the facing of the panel.

FIG. 9 is a photograph looking down on an expanded char layer on a foam core.

FIG. 10 illustrates a mesh coating line for forming intumescent-coated sheet.

FIG. 11 illustrates a panel lamination line.

FIG. 12 is an enlarged view of a portion of the panel lamination line.

### DETAILED DESCRIPTION

Unless defined otherwise, all terms of art, notations and other technical terms or terminology used herein have the same meaning as is commonly understood by one of ordinary skill in the art to which this disclosure belongs. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Unless otherwise indicated or the context suggests otherwise, as used herein, “a” or “an” means “at least one” or “one or more.”

References in the specification to “one embodiment,” “an embodiment,” a “further embodiment,” “an example,” “an exemplary embodiment,” “some aspects,” “a further aspect,” “aspects,” etc., indicate that the embodiment, example, or aspect described may include a particular feature, structure, or characteristic, but every embodiment encompassed by this disclosure may not necessarily include the particular feature, structure, or characteristic. Moreover, such phrases are not necessarily referring to the same embodiment, example, or aspect. Further, when a particular feature, structure, or characteristic is described in connection with an embodiment, such feature, structure, or characteristic is also a description in connection with other embodiments, examples, or aspects, whether or not explicitly described.

This description may use various terms describing relative spatial arrangements and/or orientations or directions in describing the position and/or orientation of a component, apparatus, location, feature, or a portion thereof or direction of movement, force, or other dynamic action. Unless specifically stated, or otherwise dictated by the context of the description, such terms, including, without limitation, top, bottom, above, below, under, on top of, upper, lower, left, right, in front of, behind, beneath, next to, adjacent, between, horizontal, vertical, diagonal, longitudinal, transverse, radial, axial, clockwise, counter-clockwise, etc., are used for convenience in referring to such component, apparatus, location, feature, or a portion thereof or movement, force, or other dynamic action represented in the drawings and are not intended to be limiting.

Unless otherwise indicated, or the context suggests otherwise, terms used herein to describe a physical and/or spatial relationship between a first component, structure, or portion thereof and a second component, structure, or portion thereof, such as, attached, connected, fixed, joined, linked, coupled, or similar terms or variations of such terms, shall encompass both a direct relationship in which the first component, structure, or portion thereof is in direct contact with the second component, structure, or portion thereof or there are one or more intervening components, structures, or portions thereof between the first component, structure, or portion thereof and the second component, structure, or portion thereof.

Unless otherwise stated, any specific dimensions mentioned in this description are merely representative of an exemplary implementation of a device embodying aspects of the disclosure and are not intended to be limiting.

To the extent used herein, the terms “about” or “approximately” apply to all numeric values and terms indicating specific physical orientations or relationships such as horizontal, vertical, parallel, perpendicular, concentric, or similar terms, specified herein, whether or not explicitly indicated. This term generally refers to a range of numbers, orientations, and relationships that one of ordinary skill in the art would consider as a reasonable amount of deviation to the recited numeric values, orientations, and relationships (i.e., having the equivalent function or result) in the context of the present disclosure. For example, and not intended to be limiting, this term can be construed as including a deviation of #10 percent of the given numeric value, orientation, or relationship, provided such a deviation does not alter the end function or result of the stated value, orientation, or relationship. Therefore, under some circumstances as would be appreciated by one of ordinary skill in the art a value of about or approximately 1% can be construed to be a range from 0.9% to 1.1%.

To the extent used herein, the term “adjacent” refers to being near (spatial proximity) or adjoining. Adjacent objects or portions thereof can be spaced apart from one another or can be in actual or direct contact with one another. In some instances, adjacent objects or portions thereof can be coupled to one another or can be formed integrally with one another.

To the extent used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as stated as well as instances in which the event, circumstance, characteristic, or property occurs to a close approximation, such as accounting for typical tolerance levels or variability of the embodiments described herein.

To the extent used herein, the terms “optional” and “optionally” or the term “may” (e.g., as in the phrase “may include,” “may comprise,” “may produce,” “may provide,” or similar phrases) mean that the subsequently described, component, structure, element, event, circumstance, characteristic, property, etc. may or may not be included or occur and that the description includes instances where the component, structure, element, event, circumstance, characteristic, property, etc. is included or occurs and instances in which it is not or does not.

To the extent used herein, the terms “first” and “second” preceding the name of an element (e.g., a component, apparatus, location, feature, or a portion thereof or a direction of movement, force, or other dynamic action) are used for identification purposes to distinguish between similar elements, and are not intended to necessarily imply order, nor are the terms “first” and “second” intended to preclude the inclusion of additional similar elements. Furthermore, use of the term “first” preceding the name of an element (e.g., a component, apparatus, location, feature, or a portion thereof or a direction of movement, force, or other dynamic action) does not necessarily imply or require that there be additional, e.g., “second,” “third,” etc., such element(s).

To the extent used herein, the terms or phrases “configured to,” “adapted to,” “operable to,” “constructed and arranged to,” and similar terms mean that the object of the term or phrase includes, constitutes, or otherwise encompasses the requisite structure(s), mechanism(s), arrangement(s), component(s), material(s), algorithm(s), circuit(s), programming, etc. to perform a specified task or tasks or achieve a specified functionality, output, or characteristic, either perpetually or selectively when called upon to do so.

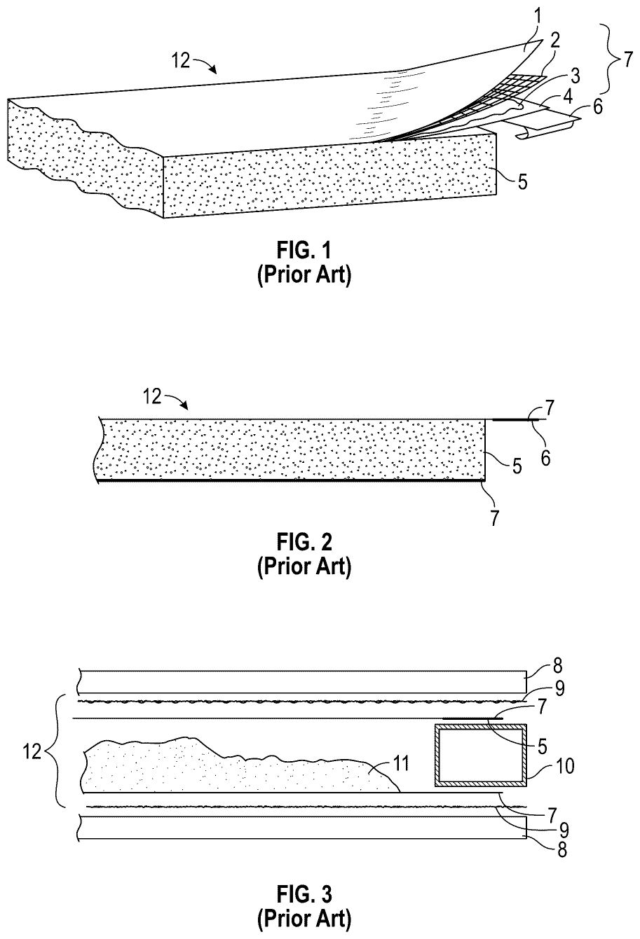

Turning now to the drawings, wherein like reference characters designate identical or corresponding parts, and more particularly to FIG. 1 thereof, a composite insulation panel 12 includes a facing 7 disposed on one side, or, alternatively, both sides, of a foam core 5. Top facing 7 of the composite panel 12 is shown in FIG. 1 pulled back to expose its components. Facing 7 may comprise, but is not limited to, a vapor impervious skin 1, preferably between 2.5 and 400 micron, beyond which a reinforcing layer may be redundant. By way of a specific example, the skin 1 is comprised of white polypropylene. Other suitable materials include a wide range of materials; for example, polystyrene, polyethylene, polypropylene, polyurethane, polyvinylchloride, and aluminum foil. In some cases, for costs savings, a facing material can become increasingly thin to a point at which it is no longer a vapor impervious skin. Thinner skins can be more cost effective, but have difficulty meeting perm ratings (i.e., water vapor transmission rate). This is the reason that reinforcing can be important. As the facing layer becomes thinner, skin 1 must be coated to achieve a desirable level of vapor permeance. By way of further specific example, the skin 1 is comprised of a layer of white polypropylene with a weight of 20 g/m², a reinforcing layer of tri-directional fiberglass, and an aluminum with a thickness of, for example, 25 microns and a bond coating of elastomeric polymer of, for example, 2.5 microns thickness.

Facing 7 further includes reinforcing 2 added to give the facing 7 its desired strength. Reinforcing 2 is comprised of, but not limited to, continuous strands of organic and non-organic fibers. In particular, continuous fibers are orientated in a mesh, or woven, pattern that maximizes composite properties. By way of example, glass and polyester fibers are presented in a tri-directional weave with at least one axis of said weave orientated along the length of composite panel 12, which can be produced in custom lengths to fit building dimensions. In some embodiments, reinforcing 2 may comprise fiberglass, Kevlar®, or carbon fiber. The width of the panel can also be customized, but 42 inches is preferable for ease of installation. To further quantify its performance, facing composite 7 should obtain minimum burst strength 25 psi and a minimum puncture resistance of 50 beach units. Furthermore, a minimum tensile strength of 25 lbs/inch width should be obtained

Facing 7 should have a class I water vapor transmission rating within a range of 0.0 perm to 0.1 perm. In one example, the permeance of the composite facing is equivalent to or greater than the permeance of the foam core 5. Heretofore prior art has put little emphasis on this aspect due to the adequate permeance rating of foam used. When considering the preferred embodiment of the insulating system presented, it becomes apparent that the installed seams should also meet a class I rating. Additionally, all facings should have a class I rating for flame spread and smoke development. Ideally, the composite insulation panel 12 has a class I or class A rating with regard to flame spreading and smoke propagation when tested to ASTM E84 criteria. Furthermore, Sections 2603.4 through 2603.7 of the international building code require that foam plastics must be separated from the interior of a building by a 15-minute thermal barrier unless special approvals in outlined in Section 2603.9 of the international building code are met. Preferably, the composite insulation panel 12 described herein satisfies the special approvals of Section 2603.9.

Facing 7 further includes a backing 4 (often referred to as a “Kraft backing”), which is used as a bonding isolation barrier. This isolation enhances bonding between the foam 5 and the facing 7 and allows for a greater diversity of facings that can be incorporated into the final composite insulation panel 12. Often molecular bonding between dissimilar plastics becomes problematic due a high degree of polymer chain alignment and hydrogen paring at the surface of the material. By way of example, ultra high molecular weight polyethylene has a tremendously low surface energy when compared to polyurethanes. By using backing 4 to isolate the materials, an adhesive 3 can be selected to molecularly and mechanically bond with facing skin 1 and backing 4, thereby locking fiber-reinforcing 3 interstices in place and forming the facing composite 7, which in turn is bonded to the foam core 5 in the same manner that the backing 4 is attached to the skin 1 and reinforcing 2.

Suitable materials to be used as a facing composite include air barriers and vapor retarders available from Lamtec® Corporation, Flanders, New Jersey, including product numbers WMP-30 and R-3035 HD WMP-VR-R PLUS. Another suitable product is “Gymguard” by Lamtec.

The thickness of the foam core 5 can vary from ½ inch to 6 inches depending on the degree of insulation required. The foam core may have a density of 1.8 to 2.6 pcf (pounds per cubic foot), preferably about 2.3 pcf.

By way of example, the foam core 5 will be made of polyurethane-modified polyisocyanurate (PU-PIR) foams. Polyurethane-modified polyisocyanurate (PU-PIR) foams with the addition of flame retardant is desirable due to its strength characteristics, thermal performance, fire retarding properties, as well as its ability to bond to facings. One example of the polyurethane-modified polyisocyanurate (PU-PIR) foam formulation that is suitable for this application is as follows: Resin; 70 parts Polyol, 12 parts Flame Retardant, 3 Parts Surfactant, 2 parts Catalyst, 15 parts 1,1,1,3,3-pentafluoropropane (HFC-245fa). Isocyanate; 55 parts P-MDI, 38 parts Diphenylmethane-4,4′-diisocyanate (MDI), 10 parts MDI Mixed Isomers.

The resin components and isocyanate components are mixed individually and in turn are mixed together while being injected into a panel fixture. Heat of reaction along with mold temperatures causes the HFC-245fa to vaporize in the mixture, thereby causing foaming to take place. The molding time depends on the panel thickness, but usually falls in the range of 25 to 45 minutes for discontinuous processes or 5 to 10 minutes for continuous processes for range of panels encompassed by this disclosure.

Additionally, polyurethane-modified polyisocyanurate (PU-PIR) foam composite can be co-blown. This means that the resin will incorporate more than one blowing agent. By way of further example, a co-blown polyurethane foam resin component is as follows: 70 parts Polyol, 12 parts Flame Retardant, 3 parts Surfactant, 2 parts Catalyst, 5 parts 1,1,1,3,3-pentafluoropropane (HFC-245fa), 12 parts tetrafluoroethane.

While polyurethane-modified polyisocyanurate (PU-PIR) foam is preferred, other cellular expanded polymeric materials can be used. For example, urethanes, polystyrenes, Polyvinyl chlorides, isocyanurates, epoxies, phenolics, with variations and mixtures of these that have density between 1 and 3 pcf and a closed cell structure ranging from 90-97% closed.

A fixture assembly for forming a composite insulation panel is shown in FIG. 3. During the formation process, composite facing 7 is mechanically suspended, e.g., by hydraulic force, between two heated platens 8 held apart by an edge spacer 10. The platen temperature is held between 85° F. and 115° F., preferably a temperature of 95° F. is reached at the surface of a textured insert 9. The spacer 10 shown in FIG. 3 is configured such that the composite panel 12 will have side edges that are substantially perpendicular to panel facing 7. Spacer 10 can also be configured to give the composite panel better thermal characteristics. By way of example spacer 10 can be configured to give the panels edges a tongue-n′-groove, or ship-lap characteristic increasing the performance of the panel by reducing thermal bypass.

Textured mold insert 9 may be used on the surfaces of the heated platens 8 to allow trapped air to escape from behind composite facing 7 as the foam 11 expands in the molding fixture. Without venting this area, air can become trapped between the facing 7 and the heated platens 8 and the composite panel will not fill properly. The texture is also used to minimize the affect of blisters. Blisters occur when worm holes, bubbles of blowing agent, amass at the interface between the expanding foam 11 and the facing 7. The texture also helps prevent creases in the facing 7 by allowing the facing to be stretched into the texture when the foam expands. The textured insert improves the flow of expanding foam 11 in the mold, decreasing the amount of gas that becomes trapped at the surface of the foam. Any small amount of gas that does become trapped is camouflage by the texture that the panel as taken on.

The composite insulation panel can be molded both by discontinuous or continues process. In discontinuous operation shown in FIG. 3, the panel's facing 7 is precut to the desired panel length and inserted into the molding fixture of equal length and foamed. All components shown in FIG. 3 are static when the foam is injected/poured into the molding fixture. In continuous operation, also depicted by FIG. 3, the panel's facing 7 is continually pulled off a roll into the mold by the movement of the molding cavity. A top and bottom textured belt; separated by the thickness of the desired panel, moves in an elongated circular orbit to hold the composite in place while the foam expands and cures. As the panel exits the moving belts, the panel is cut to length via a flying cut-off saw.

Upon exiting the molding fixture, the panel 12 has facings that overhang all major sides of the composite. At this point any number of these sides may become a tape tab. The tape tab 6 can be installed before or after the molding. Preferably the tape is automatically rolled onto the facing as it comes off its roll. Tape that is applied to the width of the panel is usually installed manually after the molding operation.

The subject matter of FIGS. 1-3, as well as systems and method for installing composite insulation panel 12, are described in U.S. Pat. No. 8,635,828.

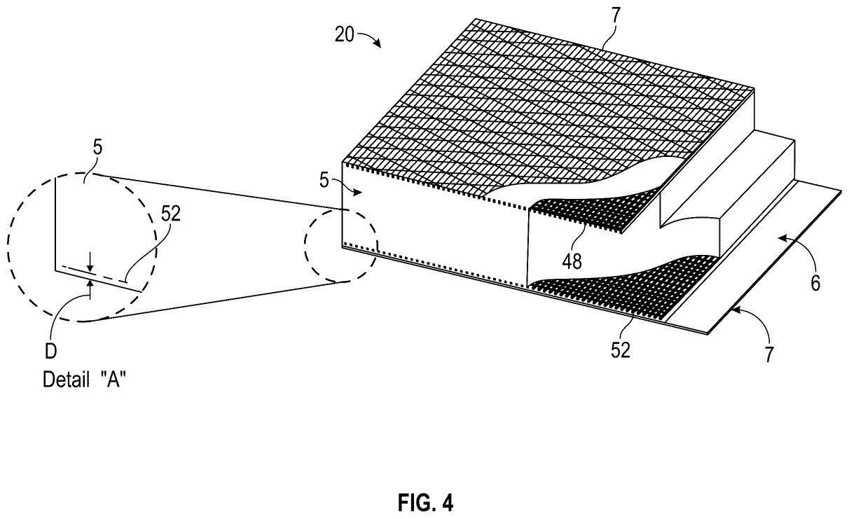

A reinforced composite panel 20 shown in FIG. 4 comprises the addition of an embedded reinforcing mesh and/or an embedded fire barrier layer to composite panel 12 described above. In one example, the embedded fire barrier layer includes a leno woven mesh that is coated on one side with an intumescent material. Leno weave (also called gauze weave or cross weave) is a weave in which two warp yarns are woven around the weft yarns to provide a strong yet sheer fabric. The standard warp yarn is paired with a skeleton or ‘doup’ yarn; these twisted warp yarns grip tightly to the weft which results the durability of the fabric. In one example, the fire barrier is embedded just below a surface of the panel.

Reinforced composite panel 20 shown in FIG. 4 includes a reinforcing mesh 48 embedded in the foam core 5 beneath a facing layer, such as facing 7, on a first side of the panel 20 and a fire barrier layer 52 at or near the surface of the foam core 5 beneath a facing layer, such as facing 7, on a second side of the panel 20 (the side corresponding to tape tab 6). The fire barrier layer 52 comprises a concentrated layer of intumescent material. In one example, the fire barrier layer 52 comprises a carrier sheet, such as a mesh, a fabric, a film, a paper product, or linear fibers, coated with an intumescent material and at least partially embedded in the foam core 5. In another example, intumescent material is not deposited on a carrier sheet but may incorporated into a flowable material that is applied to a back surface of a facing layer, such as facing 7, and during a forming process, the intumescent-infused flowable material becomes part of the foam core so that the intumescent material is at least partially embedded in the foam core 5. In still another example, a coating of intumescent material is applied to the back of a facing layer, such as facing 7, prior to forming the foam core 5 bonded to the facing so that little, if any, intumescent material is embedded in the foam core 5.

In other embodiments, a reinforcing mesh 48 without intumescent coating is embedded in the foam core 5 on one or both sides of the composite panel without any fire barrier layer, or fire barrier layer 52 is provided, e.g., at least partially embedded, on or in the foam core 5 on one or both sides of the composite panel without any uncoated reinforcing mesh. In one example, providing a reinforcing mesh 48 or an fire barrier layer 52 on both sides of the composite panel 20 can be helpful to avoid warping of the panel due to differential expansion or contraction of the foam core 5 as the foam core is cooling during the manufacturing process or when the panel 20 is exposed to heat-especially differential heat on one side of the panel versus the opposite side of the panel, such as when one side of an installed panel is exposed to exterior temperatures and the other side of the panel is exposed to interior temperatures of a building where the interior temperatures may be much warmer or cooler than the exterior temperatures.

Suitable mesh materials include fiberglass: E-Glass, S-Glass, Kevlar, carbon fiber, ceramics, stainless steel, and galvanized steel.

As noted, the fire barrier layer 52 may comprise a carrier mesh—such as reinforcing mesh 48—coated with an intumescent substance, and thus the intumescent-coated mesh fire barrier layer 52 may also provide reinforcing to the composite panel 20. The embedded mesh, coated 52 or uncoated 48, adds strength to the composite panel 20. The mesh(es) help disperse compressive loads from wall and roof cladding members and attachments by spreading loads over a greater area. Reinforcing mesh(es) also increases the resistance to internal normal forces. One example of this would be the OSHA drop test for fall protection 1926.502 (C)(4)(I).

As shown in FIG. 4 detail “A”, intumescent-coated mesh fire barrier layer 52 is embedded within the foam core 5 by a distance “D” so that the layer 52 is enclosed in a surrounding mass of foam core material. Similarly, a reinforcing mesh 48 is embedded within the foam core by a distance “D.” In one example, distance D is near the surface of the foam core 5 such that the layer 52 and mesh 48 are each closer to the surface of the foam core 5 than to the center of the thickness of the foam core (i.e., the center of the thickness being the midpoint between the top planar surface and the bottom planar surface of the foam core 5). Stated another way, the layer 52 and/or mesh 48 are embedded within the foam core 5 at a depth that is about about 24% or less of the overall thickness of the foam core 5. In one example, the layer 52 and/or mesh 48 are embedded at a depth of about 1/32 to 1/16 of an inch from the surface of the foam core 5. In another example, the reinforcing mesh 48 and/or fire barrier layer 52 may be embedded in the foam core 5 by any distance ranging from 1%, or less, of the thickness of the foam core 5 (so long as the mesh 48 or fire barrier layer 52 is enclosed in a surrounding mass of foam core material) to 50% of the thickness of the foam core 5.

Because the fire retardant is concentrated in the fire barrier layer 52, and where the fire barrier layer is at least partially embedded in the foam core 5 near the surface, fire protection is concentrated at the surface of the foam core where it is needed and provides a barrier that protects the foam core. In some examples, when fire/heat hits the insulation panel, the intumescent material may expand 250 times its original volume to protect the foam core of the panel.

In some prior art examples, fire protection was provided in foam insulation panels by mixing fire retardant materials with the foam core material. Fire retardant in the foam can negatively impact physical properties of the foam, such reducing compressive strength, dimensional stability, R-Value, and k-factor. Such negative impacts can be reduced or avoided by providing fire retardant material in the form of an intumescent-coated mesh, rather than mixed with the foam core. Intumescent-coated mesh may also reduce or eliminate the need for toxic halogenated fire retardants, such as bromine and chlorine based compounds.

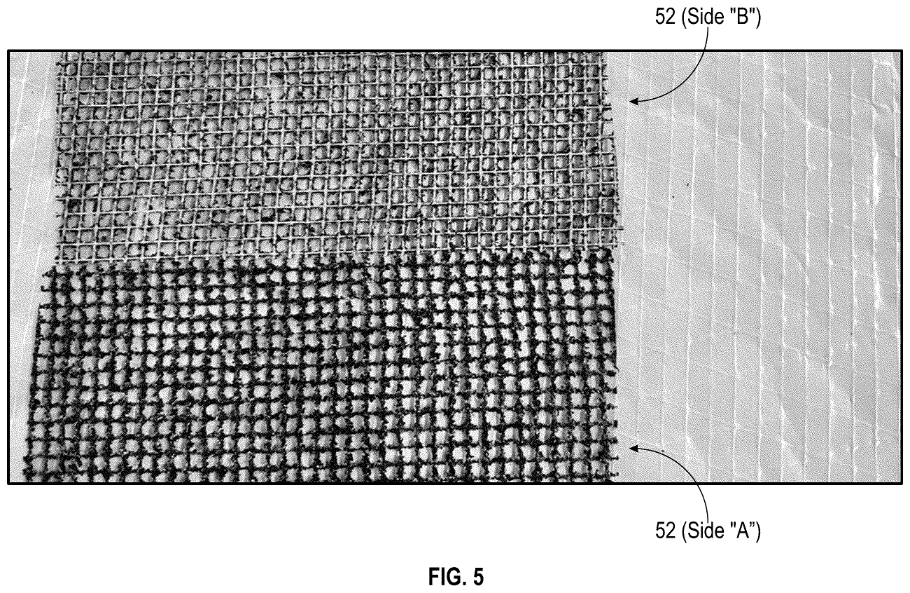

An exemplary intumescent-coated mesh fire barrier layer 52 is shown in FIG. 5, which shows opposed sides of the mesh (side “A” and side “B”). In the illustrated embodiment, intumescent coating is concentrated on side “A” of the intumescent-coated mesh 52 and substantially covers the carrier mesh, as opposed to side “B” where the carrier mesh remains visible, and substantially uncovered by the intumescent coating. The intumescent-coated mesh 52 is embedded within the panel 20 so that the “B” side (the uncoated side) faces the outer surface of the panel 20 (i.e., the “B” side faces the facing 7).

Parameters of the mesh 48 (i.e., the uncoated reinforcing mesh 48 as well as a carrier mesh used in the coated mesh fire barrier layers 52) include a leno woven glass fiber mesh with fiber spacing of about 3 mm to 12 mm warp, 3 mm to 12 mm weft, a mesh fiber weight of 70 g/m² to 160 g/m², fiber weight: warp 136 tex, weft 450 tex, warp tensile strength of 750 N/50 mm to 1555 N/50 mm, and a weft tensile strength of 826 N/50 mm to 1575 N/50 mm. Spacing of the mesh 48 should be wide enough and the fluid foam should be formulated (viscosity) to permit fluid foam core material to flow through the mesh during the panel-laminating process. The necessary mesh spacing to permit foam material to flow through the mesh will also vary with the foam viscosity. If mesh spacing is too small to permit enough foam to pass through, the foam will not be adequate adhered to the facing or mesh. If the liquid foam starts to gel (harden) too soon, its viscosity will be too high to pass through the holes in the intumescent-coated mesh.

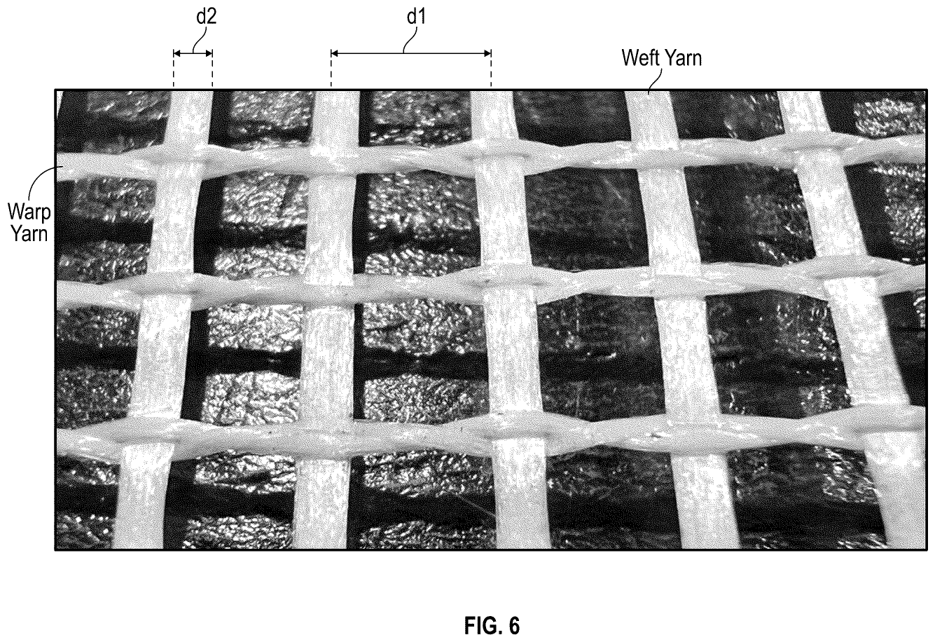

FIG. 6 is a close-up photograph showing details of an exemplary carrier mesh. As shown, two warp yarns are woven around the weft yarns. The mesh is characterized by two dimensions, d1 which is the warp/weft density, i.e., umber of yarns per unit length, and d2 is the yarn thickness exposed to intumescent coating. In one example, a ratio of yarn thickness to density (d2/d1) of 0.12 to 0.34 is an acceptable range for the mesh to be able to support a desired intumescent coating weight.

A system and method of applying the intumescent coating to achieve such differential coating density will be described below.

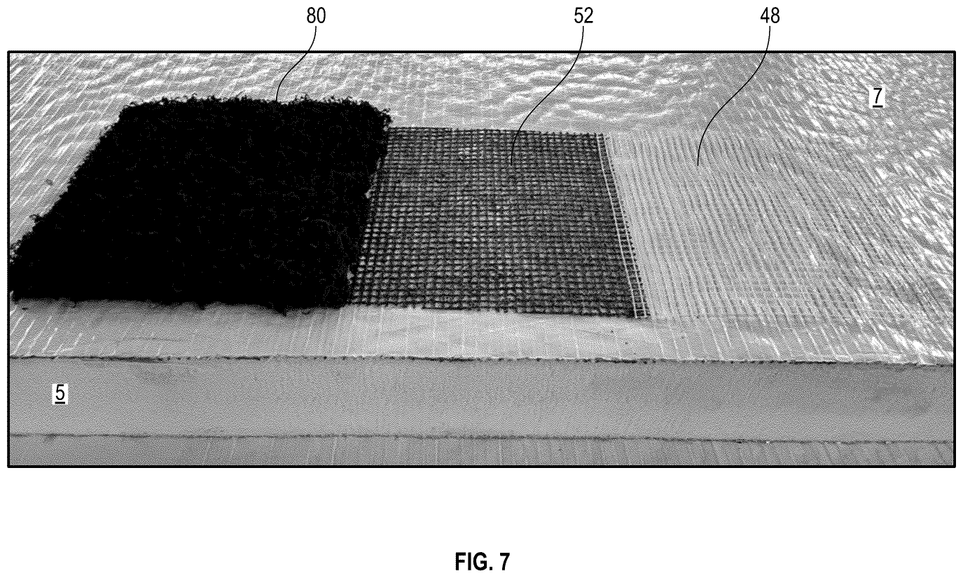

Intumescent coating provides fire protection by expanding (exfoliating) when exposed to temperature of sufficient magnitude (activation temperature). The expanded “char layer” protects the foam core 5 from open flames and direct heat. FIG. 7 is a photograph showing the uncoated carrier mesh (e.g., reinforcing mesh 48), intumescent-coated mesh 52, and the expanded (exfoliated) carbon char layer 80 after exposure to an activation temperature (e.g., 1000° F. for 5 minutes). Reinforcing mesh 48, intumescent-coated mesh 52, and carbon char layer 80 are displayed on the facing 7 attached to a foam core 5 of an in-tact panel.

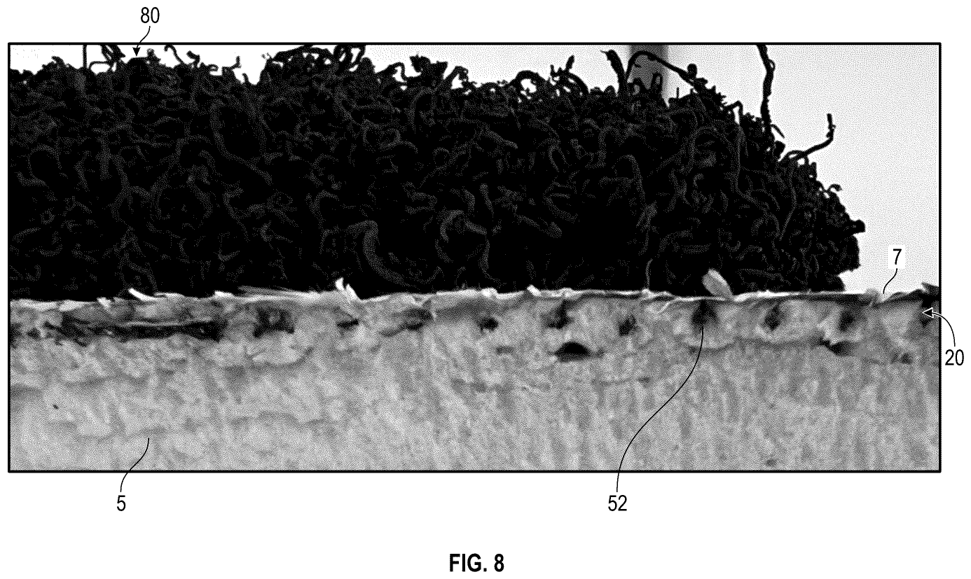

FIG. 8 is a close-up photograph of expanded carbon char layer 80 on top of a panel 20 with a layer of unexpanded intumescent-coated mesh 52 embedded within the foam core 5 below the facing 7 and illustrates the amount of expansion experienced by the char layer 80 compared to the unexpanded intumescent-coated mesh 52. As described above and shown in FIG. 5, the intumescent coating of the coated mesh 52 is provided primarily on one side of the carrier mesh (side “A”) while the opposite side of carrier mesh (side B) is substantially uncoated. When activated, the intumescent coating will expand to form the char layer on the coated side (side “A”) of the carrier mesh.

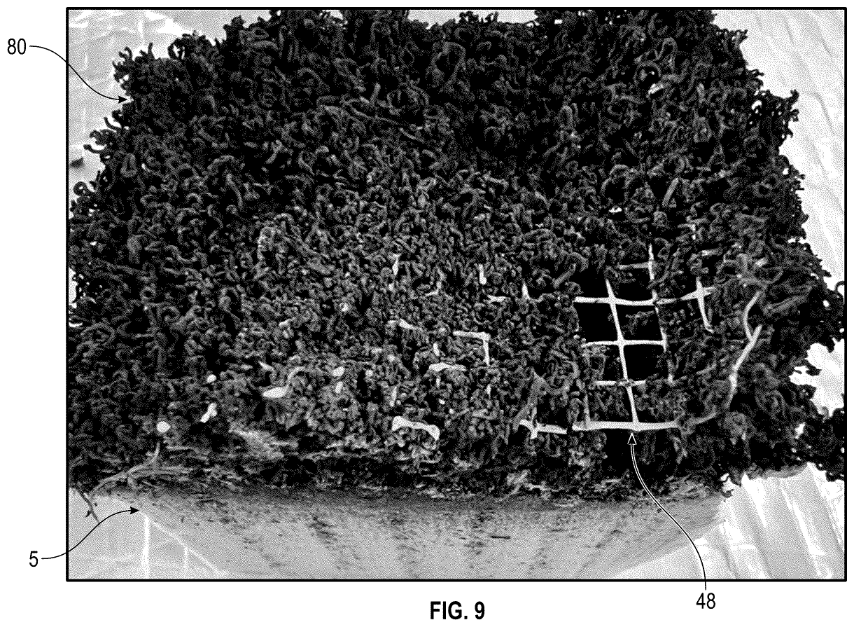

FIG. 9 is a photograph looking down on an expanded char layer 80 on a foam core 5. Because the intumescent-coated mesh 52 is embedded in the panel 20 with the coated side (FIG. 5, side “A”) facing inwardly of the foam core 5 and the uncoated side (FIG. 5, side “B”) facing outwardly of the foam core 5, the char layer on side “A” expands inwardly and pushes the carrier mesh 48 outwardly from the foam core 5. Thus, the expanded char layer 80 is substantially sandwiched between the carrier mesh 48 and the foam core 5, and the carrier mesh 48 holds the char layer 80 in place over the foam core 5 to protect the foam core 5 from open flames and direct heat.

The spacing of the carrier mesh used in the intumescent-coated mesh 52 should be small enough to support a sufficient density of intumescent coating to provide the desired fire protection.

The intumescent coating of mesh 52 may comprise expandable flake graphite with a suitable binder. A suitable binder includes a polymeric binder that adequately secures the graphite flake in place on the carrier mesh until the intumescent-coated mesh 52 is embedded in the insulation panel 20. Binders that remain flexible after drying or curing to allow the intumescent-coated mesh 52 to be re-wound are preferable in some applications. Binders with low viscosity are also desirable because the low viscosity allows additional intumescent additive to be added in higher loading percentages. A suitable binder includes PVAc-based glue.

In one example, the coating weight of the intumescent-coated mesh fire barrier layer 52—i.e., the weight of the flake and binder material that has been applied to the carrier sheet (mesh)—is 20-400 lbs./1000 ft².

Characteristics of the intumescent coating may include:
Graphite weight (expanded): about 201b/1000 ft² to 400 lb/1000 ft².
Graphite exfoliation (or activation) temperature about 160° C. to 280° C. (320° F. to 536° F.).
Graphite Expansion volume 80 cc/g to 290 cc/g
Exemplary char height 0.25 in to 4 in.

Alternate intumescent coatings that can be used instead of or in combination with flake graphite and a suitable binder include commercially available intumescent coatings based on the combination of an acid donor (catalyst), a carbonific (carbon donor), and a blowing agent. The carbon donor is an ingredient that produces char in a classical intumescent formulation. The acid donor is a catalyst or charring agent that converts the carbon donor to a protective char layer. The foam core can also help as a carbon donor when close to the expandable graphite or other acid donor. The blowing agent is a substance that releases gas in the liquid stages of the carbon donor to produce thickness in the char layer. Suitable acid generators include monoammonium phosphate, diammoium phosphate, ammonium polyphosphate, melamine phosphate, guanylurea phosphate, urea phosphate, ammonium sulfate, ammonium borate. Suitable carbonifics include sugars, maltose, arabinose, polyhydric alcohols, erythritol, pentaerythritol, dierythritol, trierythritol, arabitol, sorbitol, inositol, polhydric phenols, resorcinol, starches. Suitable spumifics include dicyandiamide, melamine, guanidine, glycine, urea, chlorinated paraffin.

Reinforced composite panel 20 may be installed on a building or other structure by any of the systems and methods described in U.S. Pat. No. 8,635,828, among other systems and methods.

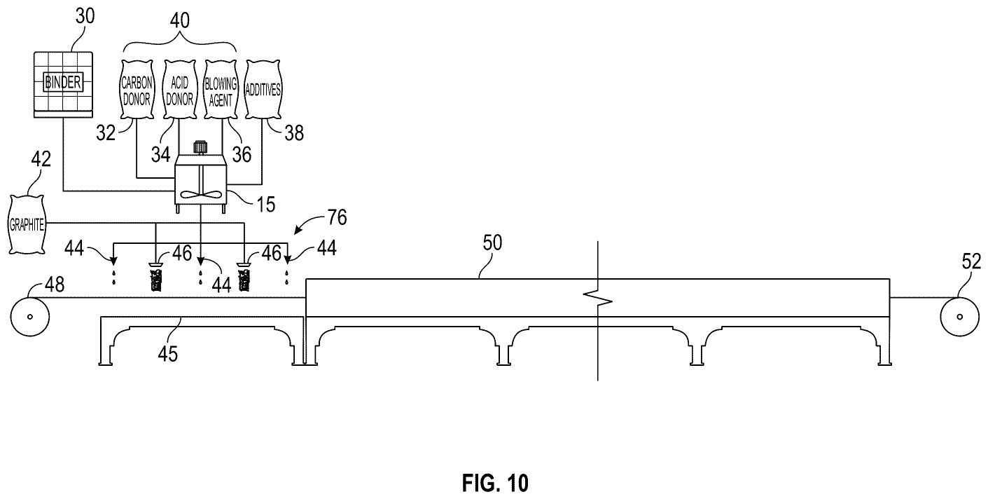

FIG. 10 illustrates a mesh coating line for forming intumescent-coated sheet 52.

Uncoated carrier sheet material, such as a mesh, a fabric, a film, a paper product, or linear fibers (or combinations of two or more thereof), is fed into the line from a roll (such as a roll 48 of reinforcing mesh in the illustrated embodiment) beneath a coating station 76 at which the intumescent coating is applied to the carrier mesh 48. Coating station 76 may comprise alternating binder sprayers 44 extending along the width of the mesh 48 and graphite deposit devices 46 extending along the width of the mesh 48. Binder is deposited on the top of the carrier mesh 48 by the binder sprayers 44. PWM (pulse width modulated) spray dispensers are desirable to control the amount of binder applied. Roll coating or binder application operations can be used. At the graphite deposit devices 46, expandable flake graphite is dropped on the wet binder by a powder dispensing vibration hoper. Because the binder and flake graphite are applied from above the carrier mesh 48, differential coating density is achieved as shown in FIG. 5 and described above. Alternating applications of binder and graphite flakes may be repeated multiple times until desired coating thickness is achieved. The number of sprayers 44 and deposit devices 46 can be selected or selected rows of sprayers 44 and deposit devices 46 can be activated or not to control the thickness of intumescent coating applied to the mesh 48. Thus, the amount of intumescent coating that is applied to the sheet can be selectively varied to increase or decrease the fire protection provided by the intumescent-coated sheet in accordance with building code requirements. Various tests specified by building codes can include: ASTM E84, UL 1715, NFPA 285 & 286, ULC S102, ULC S138, ASTM E119 15 min 1 hr 2 hr, and ASTM E108 among others.

The last application of the coating station 76 may be a binder sprayer 44 to encase the final application of flake graphite in a coating of binder material.

Graphite flake is provided to the graphite deposit devices 46 from a graphite hopper 42. Binder is provided to the binder sprayers 44 from a binder tank 30, and binder may pass through a binder blending tank 15 for blending the ingredients to a homogeneous mixture.

In an embodiment, where the carrier sheet is a mesh, binder overspray (i.e., binder that passes through the mesh without contacting any fiber) is collected in an inclined binder tray at area 45 below the sprayers 44 and pumped back to the mixing tank binder blending tank 15. The returned binder may be filtered to remove any graphite flake that may have fallen into the binder collection tray. Graphite flake that falls through the mesh without adhering to any fiber may be collected in an inclined flake tray at area 45 below the deposit devices 46, and a tub conveyor or similar device may be used to convey the collected flakes back to the graphite hopper 42. In one example, a separate binder collection tray is provided under each row of sprayers 44 and a separate flake collection tray is provided under each row of deposit devices 46.

Where other intumescent coatings are employed-instead of or in addition to graphite flake—the mesh coating line may include tanks or hoppers 40 for providing the carbon donor material 32, the acid donor material 34, and the blowing agent 36. The mesh coating line may include a tank or hopper 38 for supplying additives to improve some aspect of the intumescent properties (e.g., mechanical properties). Exemplary additives include mineral fibers, titanium dioxide, silicon dioxide, fumed silica, zinc borate, melamine borate, and magnesium silicate.

The various ingredients may be combined and mixed in the mixer 15 and then transported to the one or more sprayers 44.

After the coating is applied to the carrier mesh 48 at the coating station 76, the now-coated mesh is passed through an oven 50 to dry or cure the binder holding the intumescent material to the carrier mesh. The temperature of the oven 50 and the dwell time that the mesh remains in the oven 50 should be sufficient to dry or cure the binder without activating (i.e., expanding) the intumescent material. In one example, the oven comprises infrared heaters operated at about 200° F. (well below the exemplary activation temperature of 392° F.), and the dwell time (i.e., the time the mesh remains in the oven 50) may be 5 to 7 minutes in one example.

After passing through the oven 50, the now cured intumescent-coated mesh 52 may be rolled onto a roller or fed directly into a panel lamination line.

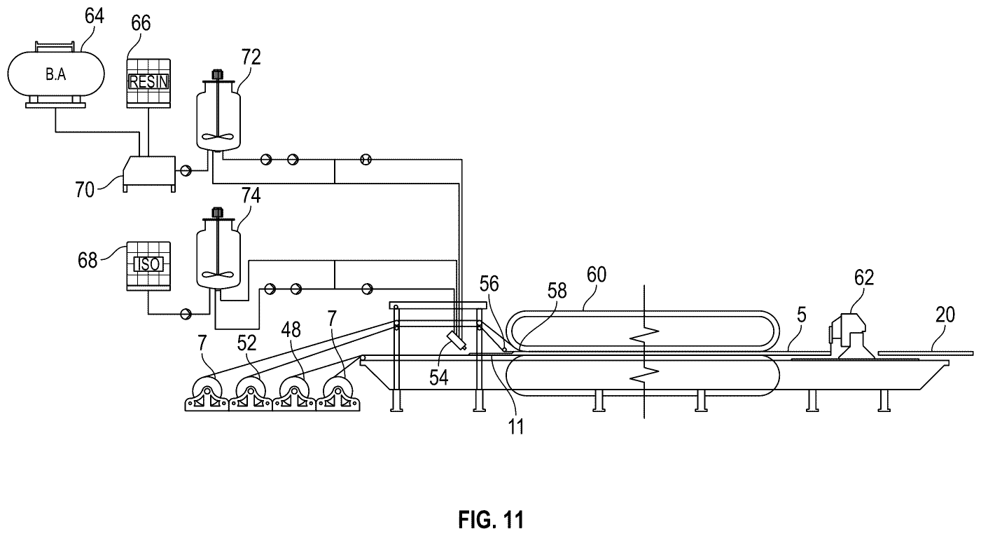

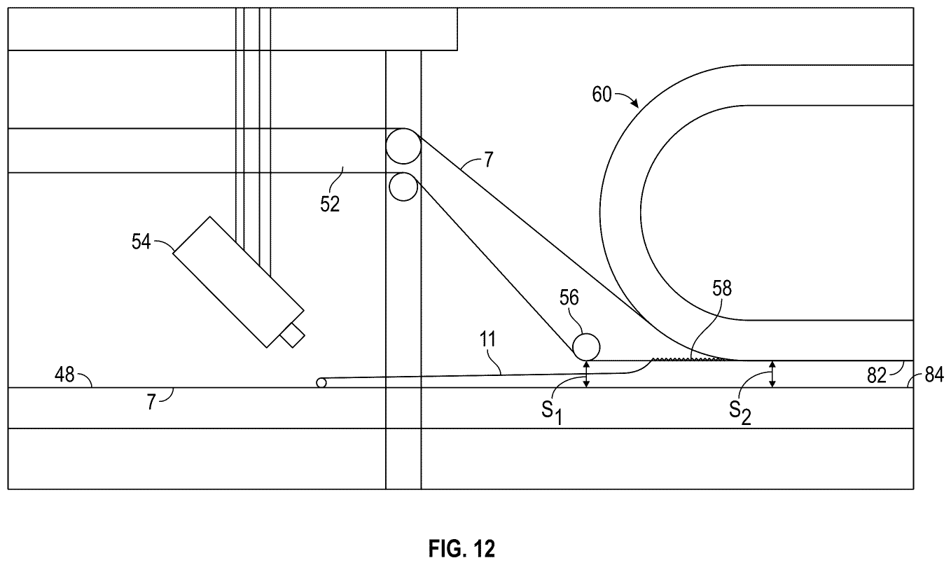

FIG. 11 illustrates a panel lamination line, and FIG. 12 is an enlarged view of a portion of the panel lamination line.

Intumescent-coated mesh is provided from roll 52, uncoated reinforcing mesh is provided from roll 48, and two layers of panel facing is provided from two rolls 7. Foam blowing agent is provided from tank or hopper 64 and resin blend is provided from tank or hopper 66 to blowing agent addition 70 and then to resin pressurized condition tank 72. Isocyanurate is provided from tank or hopper 68 to iso pressurized condition tank 74. Tanks 72 and 74 are connected to high pressure mix head 54, which blends the foam components from tanks 72 and 74 and begins the foam reaction. High pressure mix head 54 dispenses a liquid foaming mixture 11 between the upper and lower facing layers 7, the intumescent-coated mesh 52, and the uncoated mesh 48 at a mesh embedding zone 58. The liquid foaming mixture 11, layers of facing 7, uncoated mesh 48, and the intumescent-coated mesh 52 pass into a double belt lamination line 60, which provides a temperature controlled, constrained rise zone that cures and molds the foam to its desired thickness. Operating parameters, e.g., operating temperatures, of the double belt lamination line 60 are similar to those of the fixture assembly described above and shown in FIG. 3. Exemplary dwell times of the laminate within the double belt lamination line 60 may be 4-7 minutes for continuous operation.

A pinch roller 56 is provided to create a partially constrained rise zone before entering the fully constrained rise zone of the double belt lamination line 60 and to control the depth at which the intumescent-coated mesh 52 is embedded in the foam 11. As shown in FIG. 12, to ensure that the intumescent-coated mesh 52 is properly embedded into the foam core 50, a spacing S₁ between an upper surface 84 of a lower belt of the double belt lamination line 60 and the bottom of the pinch roller 56 may be less than a spacing S₂ between the upper surface 84 of the lower belt of the double belt lamination line 60 and a lower surface 82 of an upper belt of the double belt lamination line 60.

A flying cutoff saw 62 is positioned after the double belt lamination line 60 to cut the laminate exiting lamination line 60 into panels 20.

All possible combinations of elements and components described in the specification are contemplated and considered to be part of this disclosure. It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the scope of this disclosure.

1. A composite building insulation panel comprising:
a rigid foam core having a planar surface;
a facing bonded to the planar surface, the facing comprising:
an outer skin layer; and
a reinforcing layer between the planar surface and the outer skin layer and comprising woven fibers; and
at least one layer of mesh embedded within the foam core to reinforce the foam core.

2. The composite building panel of claim 1, wherein the mesh is a carrier mesh coated with an intumescent material.

3. The composite building panel of claim 2, wherein the carrier mesh comprises a leno mesh in which two warp yarns are woven around the weft yarns, wherein the mesh is characterized by dimensions d1 which is the warp/weft density, i.e., umber of yarns per unit length, and d2 which is the yarn thickness, and wherein a ratio of yarn thickness to density (d2/d1) is 0.12 to 0.34.

4. The composite building panel of claim 1, wherein materials of the mesh include at least one of fiberglass, including E-Glass and/or S-Glass, Kevlar®, carbon fiber, ceramics, stainless steel, and galvanized steel.

5. The composite building panel of claim 2, wherein the intumescent material comprises flake graphite.

6. The composite building panel of claim 2, wherein the intumescent material is bound to the carrier mesh by a PVAc-based glue.

7. The composite building panel of claim 6, wherein the graphite flake exfoliates at a temperature of 320° F. to 536° F. (160° C. to 280° C.).

8. The composite building panel of claim 2, wherein the intumescent material is coated primarily on only one side of the carrier mesh.

9. The composite building panel of claim 1, wherein the mesh is embedded within the foam core below the planar surface of the foam core at a depth that is closer to the planar surface than to a center of a thickness of the foam core.

10. The composite building panel of claim 1, wherein the foam core has opposed planar surfaces and wherein the at least one layer of mesh embedded within the foam core comprises a first layer of reinforcing mesh embedded in the foam core near one of the opposed planar surfaces and a second layer of reinforcing mesh embedded in the foam core near the other of the opposed planar surfaces.

11. The composite building panel of claim 10, wherein at least one of the first layer of reinforcing mesh and the second layer of reinforcing mesh is coated with an intumescent material.

12. The composite building insulation panel of claim 1, wherein the facing extends beyond an edge of the foam core.

13. The composite building insulation panel of claim 12, further comprising an adhesive applied to a portion of the facing extending beyond the edge of foam core.

14. The composite building insulation panel of claim 1, wherein the outer skin layer is at least partially vapor impervious.

15. The composite building insulation panel of claim 14, wherein the outer skin layer is configured to have a class I water vapor transmission rating of 0.0 perm to 0.1 perm.

16. The composite building insulation panel of claim 1, wherein the outer skin layer comprises plastic film.

17. The composite building insulation panel of claim 1, wherein the outer skin layer is comprised of a material selected from the group consisting of metalized polypropylene, polystyrene, polyethylene, polypropylene, polyurethane, and polyvinylchloride.

18. The composite building insulation panel of claim 1, wherein the foam core comprises polyurethane foam.

19. A coating line for forming an intumescent-coated sheet and comprising at least one row of binder sprayers and at least one row of deposit devices, wherein each row of binder sprayers is configured to apply a binder material to a carrier sheet passing though the line and each row of deposit devices is configured to deposit flake material onto a portion of the carrier sheet that is coated with a binder.

20. A composite building insulation panel comprising:
a rigid foam core having a planar surface;
a facing bonded to the planar surface, the facing comprising:
an outer skin layer; and
a reinforcing layer between the planar surface and the outer skin layer and comprising woven fibers; and
a fire barrier layer applied to or embedded within the foam core and disposed beneath the facing so as to be closer to the planar surface than to a center of a thickness of the foam core, wherein the fire barrier layer comprises an intumescent material.

21. The composite building panel of claim 20, wherein the fire barrier layer comprises a carrier sheet on which the intumescent material is coated.

22. The composite building panel of claim 20, wherein the carrier sheet comprise at least one of a mesh, a fabric, a film, a paper product, or linear fibers.

23. The composite building panel of claim 20, wherein the carrier sheet comprises a reinforcing mesh.

24. The composite building panel of claim 21, wherein the carrier sheet comprises a leno mesh in which two warp yarns are woven around the weft yarns, wherein the mesh is characterized by dimensions d1 which is the warp/weft density, i.e., umber of yarns per unit length, and d2 which is the yarn thickness, and wherein a ratio of yarn thickness to density (d2/d1) is 0.12 to 0.34.

25. The composite building panel of claim 22, wherein the carrier sheet comprises a mesh including at least one of fiberglass, including E-Glass and/or S-Glass, Kevlar®, carbon fiber, ceramics, stainless steel, and galvanized steel.

26. The composite building panel of claim 20, wherein the intumescent material comprises flake graphite.

27. The composite building panel of claim 21, wherein the intumescent material is bound to the carrier sheet by a PVAc-based glue.

28. The composite building panel of claim 26, wherein the graphite flake exfoliates at a temperature of 320° F. to 536° F. (160° C. to 280° C.).

29. The composite building panel of claim 21, wherein the carrier sheet comprises a carrier mesh and the intumescent material is coated primarily on only one side of the carrier mesh.

30. The composite building panel of claim 20, wherein the fire barrier layer is embedded within the foam core at a depth of about 1/32 inch to 1/16 inch below the planar surface of the foam core.

31. The composite building insulation panel of claim 20, wherein the facing extends beyond an edge of the foam core.

32. The composite building insulation panel of claim 31, further comprising an adhesive applied to a portion of the facing extending beyond the edge of foam core.

33. The composite building insulation panel of claim 20, wherein the outer skin layer is at least partially vapor impervious.

34. The composite building insulation panel of claim 33, wherein the outer skin layer is configured to have a class I water vapor transmission rating of 0.0 perm to 0.1 perm.

35. The composite building insulation panel of claim 20, wherein the outer skin layer comprises plastic film.

36. The composite building insulation panel of claim 20, wherein the outer skin layer is comprised of a material selected from the group consisting of metalized polypropylene, polystyrene, polyethylene, polypropylene, polyurethane, and polyvinylchloride.

37. The composite building insulation panel of claim 20, wherein the foam core comprises polyurethane foam.

38. The composite building insulation panel of claim 37, wherein the foam core comprises polyurethane-modified polyisocyanurate (PU-PIR) foam.

39. The composite building insulation panel of claim 21, wherein a coating weight of the intumescent-material on the carrier sheet is 20-400 lbs./1000 ft².
